(19) United States
(12) Patent Application Publication
(10) Pub. No.: US 2014/0097256 A1
(43) Pub. Date: Apr. 10, 2014

(54) FAUCET

(71) Applicant: Tsai-Chen YANG, Taichung City (TW)

(72) Inventor: Tsai-Chen YANG, Taichung City (TW)

(21) Appl. No.: 14/102,415

(22) Filed: Dec. 10, 2013

Related U.S. Application Data
(63) Continuation-in-part of application No. 12/770,596, filed on Apr. 29, 2010.

(51) Int. Cl. G05D 23/13

(52) U.S. Cl. CPC G05D 23/1313
USPC 236/12.2

(57) ABSTRACT

A faucet has a multiway tube and a water mixer installed in the multiway tube. The water mixer has a balance unit and a mixing element, and the water mixer can be connected to two water sources. When the pressure of one water source varies rapidly, the balance element can modulate the effect that may influence the flow rate of each water source. The mixing element is, on the other hand, adapted to mix the two water flows. As such, the faucet of the present invention can stabilize the temperature of the mixed water outlet.

### FIELD OF THE INVENTION

The present invention is a CIP of application Ser. No. 12/770,596, filed Apr. 29, 2010, the entire contents of which are hereby incorporated by reference.

### BACKGROUND OF THE INVENTION

### Description of the Prior Art

A conventional faucet may be provided with a mixing property to mix two water flows, e.g. a hot water flow and a cold water flow. However, the temperature of the mixed water sometimes changes suddenly when the water pressure of one of the water sources drops. Thus the conventional faucet is a potential threat to the user in that the user may be scalded.

For example, the water mixer disclosed in U.S. Pat. No. 7,344,088 has a temperature-regulation valve and a balance valve which are installed into specific spaces of the faucet having specific shapes. That is, the faucet has to be shaped with flow channels and cavities having specific shapes and sizes in advance for receiving the temperature-regulation valve and the balance valve. Thus, manufacturing becomes difficult and complicated, and the size of each component is extremely restricted. Also, installation is not convenient, so it is difficult for a customer to install or repair.

Another example is disclosed in U.S. Pat. No. 6,050,285. The balance valve includes two cartridges and a sliding member inside. The sliding member is kept in center due to elasticity of a membrane. When the cold water pressure and the hot water pressure vary, water pressure overcomes the elasticity to move the sliding member. Thus, cross-sections of cold water and hot water are increased or decreased respectively so that cold water flow and hot water flow are regulated. However, all the components including the balance valve and control member are independent to each other and are installed into the receiving seat of the faucet one by one respectively. Thus, water may leak out via the gap between any two components. In addition, installation is also difficult, and the sizes of the components are also strictly restricted.

The present invention is, therefore, arisen to obviate or at least mitigate the above mentioned disadvantages.

### SUMMARY OF THE INVENTION

The main object of the present invention is to provide a faucet that can balance the flow rate of two water flows.

To achieve the above and other objects, the faucet of the present invention, comprises a multiway tube and a water mixer.

The multiway tube has a receiving portion, a cold water inlet, a hot water inlet, and an outlet. The cold water inlet, the hot water inlet, and the outlet communicate with a bottom of the receiving portion.

The water mixer includes a shell, a balance element, a mixing element, and an adjusting element.

The shell has a transversal plate, the transversal plate having a first surface and a second surface. A first chamber being defined between the first surface and the shell, and a second chamber and a third chamber is defined between the second surface and the shell. The transversal plate is formed with a first passage and a second passage. Both of the first passage and the second passage communicate the first chamber with the second chamber. The third chamber is isolated from the second chamber. The third chamber is located below the first chamber and is communicated with the first chamber. The second chamber is below the first chamber and communicates with the cold water inlet and the hot water inlet of the multiway tube. The third chamber communicates with the outlet of the multiway tube.

The balance element comprises a first tube unit, a second tube unit and a pressure balancer. The tube units are disposed in the second chamber. The first tube unit has a through hole communicated with the first passage, and the second tube unit has a through hole communicated with the second passage. Each tube unit has a lateral bore communicated with its through hole. The lateral bores of the tube units face each other. A receiving space is defined between the lateral bores. The pressure balancer is movably disposed in the receiving space. The pressure balancer includes a sleeve and a movable rod. The sleeve is disposed in the receiving space and has a first hole and a second hole. The first hole communicates with the cold water inlet of the multiway tube. The second hole communicates with the hot water inlet of the multiway tube. The movable rod is slidably disposed in the sleeve and has a blocked center part to partition an exterior of the movable rod into a cold water cavity and a hot water cavity. The cold water cavity and the hot water cavity communicate with the two through holes respectively. The movable rod is formed a first inlet and a second inlet on a bottom thereof. The first inlet communicates with the cold water cavity and the first hole. The second inlet communicates with the hot water cavity and the second hole. When variation between cold water and hot water changes, the movable rod is pushed by water to change overlapping area between the first hole and the first inlet and the overlapping area between the second hole and the second inlet so as to change ratio of cold water amount and hot water amount.

The mixing element is disposed in the first chamber. The mixing element is adapted to regulate water to enter the first chamber via the first and second passages and to regulate the water in the first chamber to flow to the third chamber. The adjusting element connects to the mixing element. The adjusting element is adapted to control a movement of the mixing element so as to further adjust a mixing ratio of a flow rate in the first passage to a flow rate in the second passage.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a breakdown drawing of the present invention;

FIG. 2 is a stereogram showing a water mixer of the present invention;

FIG. 2A is a partial breakdown drawing showing a water mixer of the present invention;

FIG. 3 is a breakdown drawing showing a water mixer of the present invention;

FIG. 3A is a top view showing a shell of the present invention;

FIG. 3B is a perspective drawing showing a shell of the present invention;

FIG. 3C is a perspective drawing showing a tube unit of the present invention;

FIG. 4 is a profile showing a water mixer of the present invention;

FIGS. 5 and 6 are illustrations of operation showing a second embodiment of the present invention;

FIG. 7 is a breakdown drawing showing a water mixer in accordance with a second embodiment of the present invention;

FIG. 8 is a profile of the present invention.

### DETAILED DESCRIPTION OF THE PREFERRED EMBODIMENTS

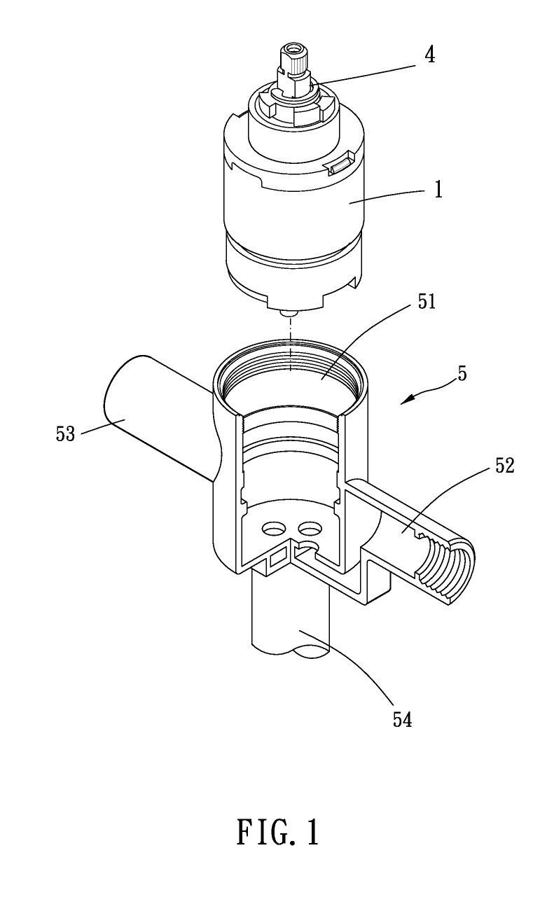

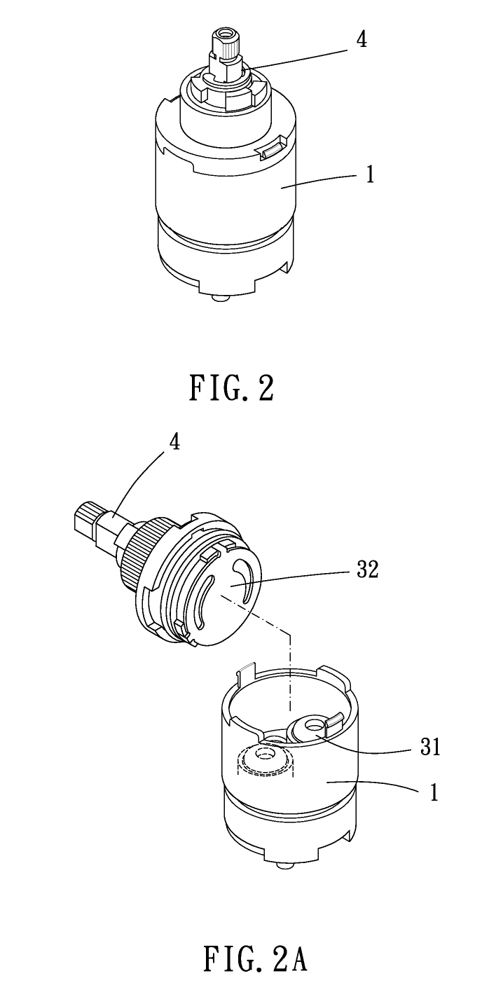

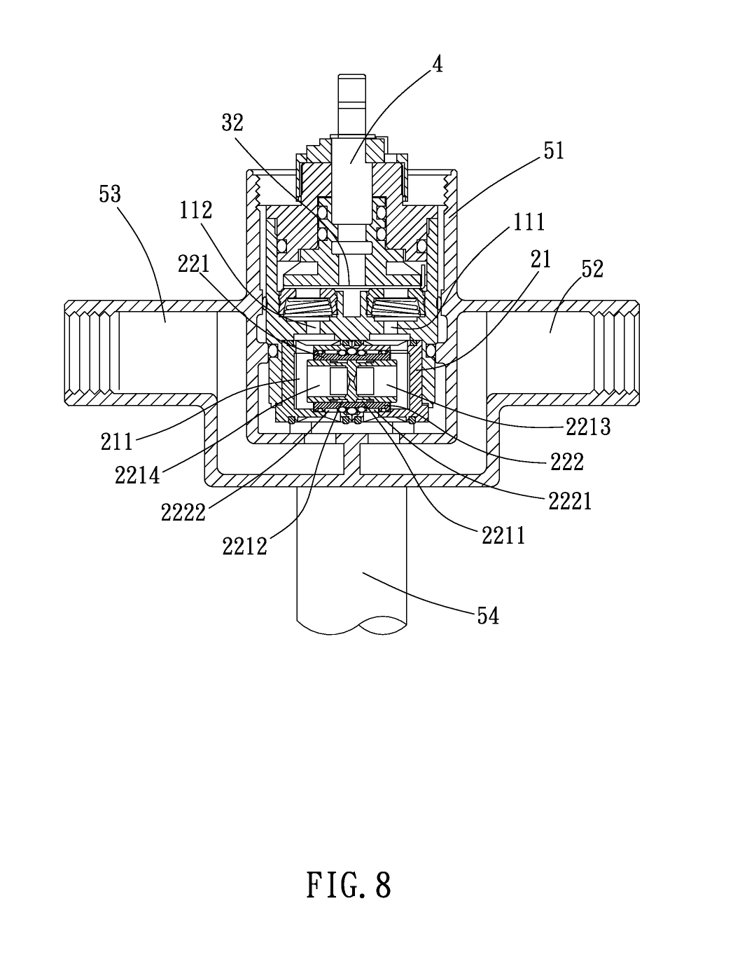

Please refer to FIGS. 1, 2, 2A, 3, 3A, 3B, 3C, 4, and 8. A faucet of the present invention includes a multiway tube 5, a shell 1, a balance element 2, a mixing element 3 and an adjusting element 4.

The multiway tube 5 is adapted for being installed in a shower room or other places. The multiway tube 5 has a receiving portion 51, a cold water inlet 52, a hot water inlet 53, and an outlet 54. The cold water inlet 52, the hot water inlet 53, and the outlet 54 all communicate with a bottom of the receiving portion 51 respectively.

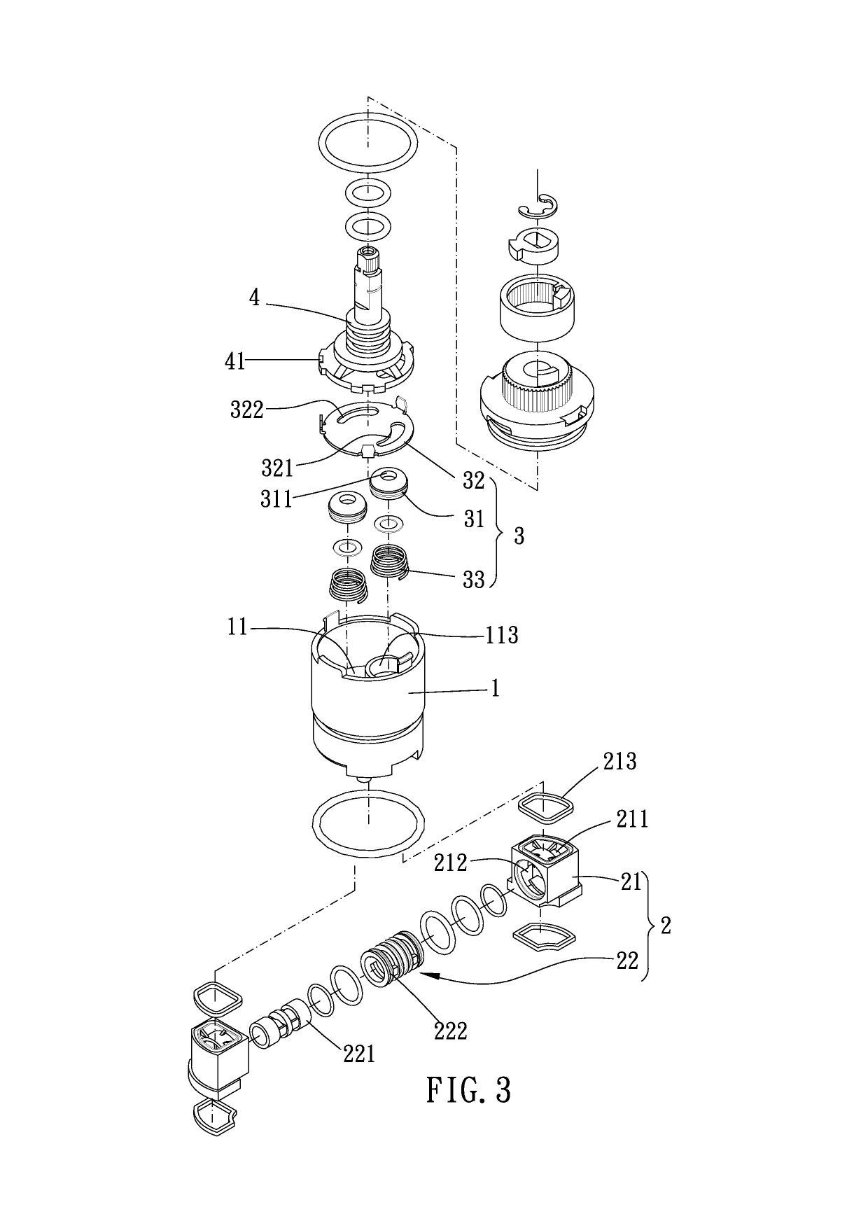

The shell 1 may be an integral-formed cylindrical body. Please refer to FIG. 3A and FIG. 3B. The shell 1 has transversal plate 11 which is perpendicular to the axial direction of the shell 1. The transversal plate 11 has a first surface and a second surface. A first chamber 12 is defined between the first surface and the shell 1. A second chamber 13 and a third chamber 14 are defined between the second surface and the shell 1, in which the third chamber 14 is isolated from the second chamber 13. The transversal plate 11 is formed with a first passage 111 and a second passage 112, both of which communicate the first chamber 12 with the second chamber 13. Two annular rims 113 are axially extended from the first surface of the transversal plate 11, and the annular rims 113 surround one of the first and second passages 111 and 112 respectively. In addition, the third chamber 14 is communicated with the first chamber 12 via a channel formed on the transversal plate 11 and is located below the first chamber 12. The second chamber 13 communicates with the cold water inlet 52 and the hot water inlet of the multiway tube 5. The third chamber 14 communicates with the outlet 54 of the multiway tube 5.

Please refer to FIG. 3. The balance element 2 includes two tube units 21 and a pressure balancer 22. The tube units 21 are disposed in the second chamber 13 and abut against the shell 1 at their outer surfaces. Each tube unit 21 has a through hole 211 communicated with one of the passages 111 and 112. Each tube unit 21 further has a lateral bore 212 communicated with its through hole 211. The lateral bores 212 of the tube units 21 face each other, and a receiving space is defined between the lateral bores 212 for the pressure balancer 22 to movably dispose therein. Specifically, the two tube units 21 abut against each other. Gaskets 213 can be provided between the tube units 21 and the transversal plate 11. Please refer to FIG. 3C. Two blocking plates 214 are disposed in each of the through holes 211 of the tube units 21. The tube units 21 further have several intensifying plates 215, each of which connects one of the blocking plates 214 with its corresponding tube unit 21. The intensifying plates 215 are arranged parallel to an orientation of the through hole 211. More specifically, each intensifying plate 215 has a surface, which has a normal direction. And the orientation of the through hole is perpendicular to the normal direction. Please refer to FIG. 3 again. The pressure balancer 22 isolates the two through holes 211 from each other. The pressure balancer 22 includes a sleeve 22 and a movable rod 221 that is movable in the sleeve 222. The pressure balancer 22 includes a sleeve 222 and a movable rod 221. The sleeve 222 is disposed in the receiving space and has a first hole 2221 and a second hole 2222. The first hole 2221 communicates with the cold water inlet 52 of the multiway tube 5. The second hole 2222 communicates with the hot water inlet 53 of the multiway tube 5. The movable rod 221 is slidably disposed in the sleeve 222 and has a blocked center part to partition an exterior of the movable rod 221 into a cold water cavity 2213 and a hot water cavity 2214. The cold water cavity 2213 and the hot water cavity 2214 communicate with the two through holes 211 respectively. The movable rod 221 is formed a first inlet 2211 and a second inlet 2212 on a bottom thereof. The first inlet 2211 communicates with the cold water cavity 2213 and the first hole 2221. The second inlet 2212 communicates with the hot water cavity 2214 and the second hole 2222. When variation between cold water and hot water changes, the movable rod 221 is pushed by water to change overlapping area between the first hole 2221 and the first inlet 2211 and the overlapping area between the second hole 2222 and the second inlet 2212 so as to change ratio of cold water amount and hot water amount. For example, when hot water pressure is larger than cold water pressure, hot water pushes the movable rod 221 toward the through hole 211 of cold water. Thereby, due to the deviating movable rod 221, cross-section of cold water flow is increased, and the cross-section of hot water flow is decreased.

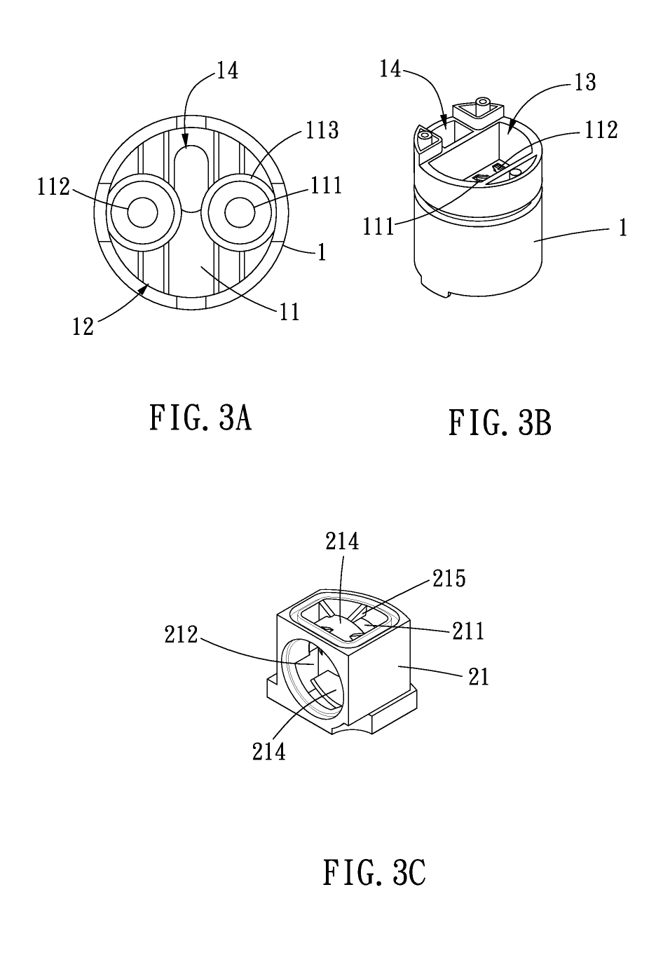

The mixing element 3 is disposed in the first chamber 12, and the mixing element 3 is adapted to regulate water to enter the first chamber 12 via the first and second passages 111 and 112 and to regulate the water in the first chamber 12 to flow to the third chamber 14. More specifically, the mixing element 3 includes two sealing gaskets 31, a throttle disc 32 and two resilient members 33. The sealing gaskets 31 abut against the transversal plate 11 respectively, and each sealing gasket 31 defines a through bore 311 communicated with one of the first and second passages 111 and 112. Please refer to FIG. 4, the sealing gaskets 31 are preferably tightly surrounded by the annular rims 113 respectively. The throttle disc 32 abuts against the sealing gaskets 31, and the throttle disc 32 is formed with a first slot 321 and a second slot 322. The resilient members 33 abut against the transversal plate 11 and the gaskets 31 respectively, so as to push the gaskets 31 to abut against the throttle disc 32 tightly.

Please refer to FIG. 3 and FIG. 4. The adjusting element 4 connects to the mixing element 3, and the adjusting element 4 is adapted to control a movement of the mixing element 3 so as to further adjust a mixing ratio of a flow rate in the first passage 111 to a flow rate in the second passage 112. Specifically, the adjusting element 4 and the throttle disc 32 are in a rotational operative relationship, so that the first and second slots 321 and 322 are controlled to selectively communicate the through bores 311 with the first chamber 12 respectively. More specifically, several protrusions 32 may be extended from the throttle disc 32 toward the adjusting element 4, while the adjusting element 4 may be correspondingly formed with several grooves 41 to engage with the protrusions 32. As such, the adjusting element 4 and the throttle disc 32 are in a rotational operative relationship, and the throttle disc 32 is rotated when the adjusting element 4 is turned.

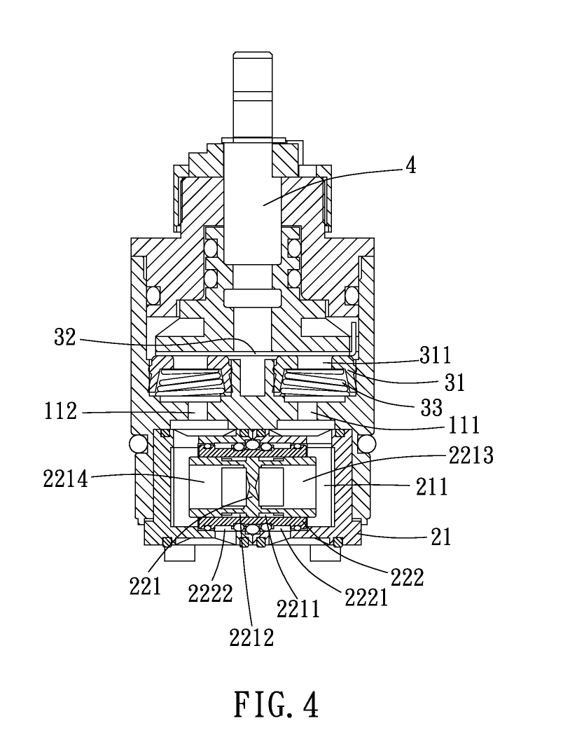

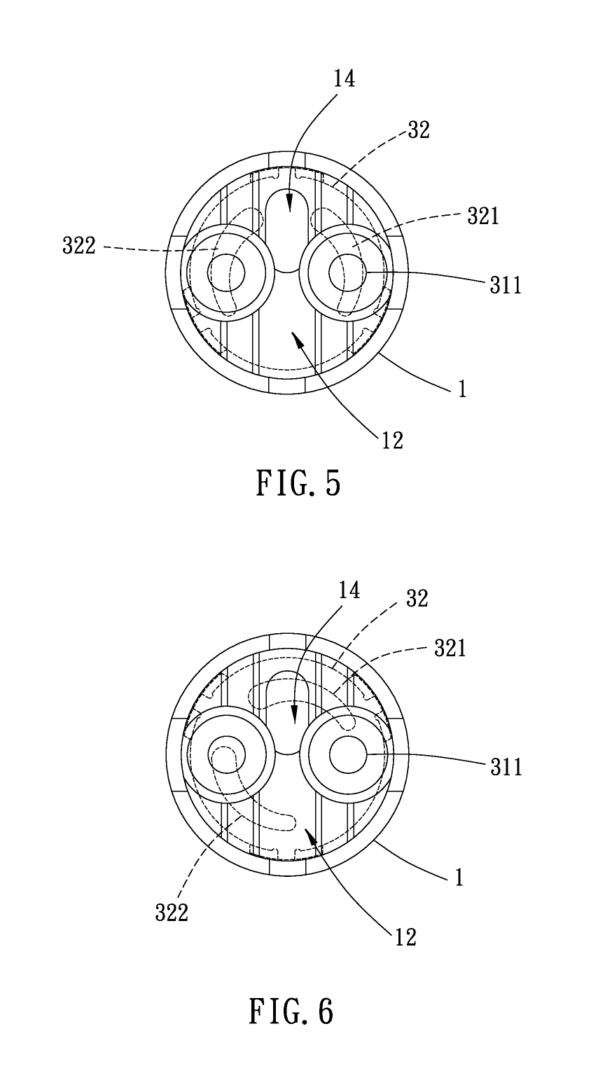

Please refer to FIG. 4. The through holes 211, the passages 111 and 112 and the through bores 311 define two inlet conduits which connects to two water sources respectively. Please refer to FIG. 5. The slots 322 communicate with the through bores 311 respectively, so that the water in the water source can be conducted into the first chamber 12 and then be evacuated via the third chamber 13. The mixing ratio is controlled when the adjusting element 4 is turned. Or, as shown in FIG. 6, one of the through bores 311 is blocked when the throttle disc 32 is further rotated. As such, the water in the first chamber 12 is totally provided by a single water source.

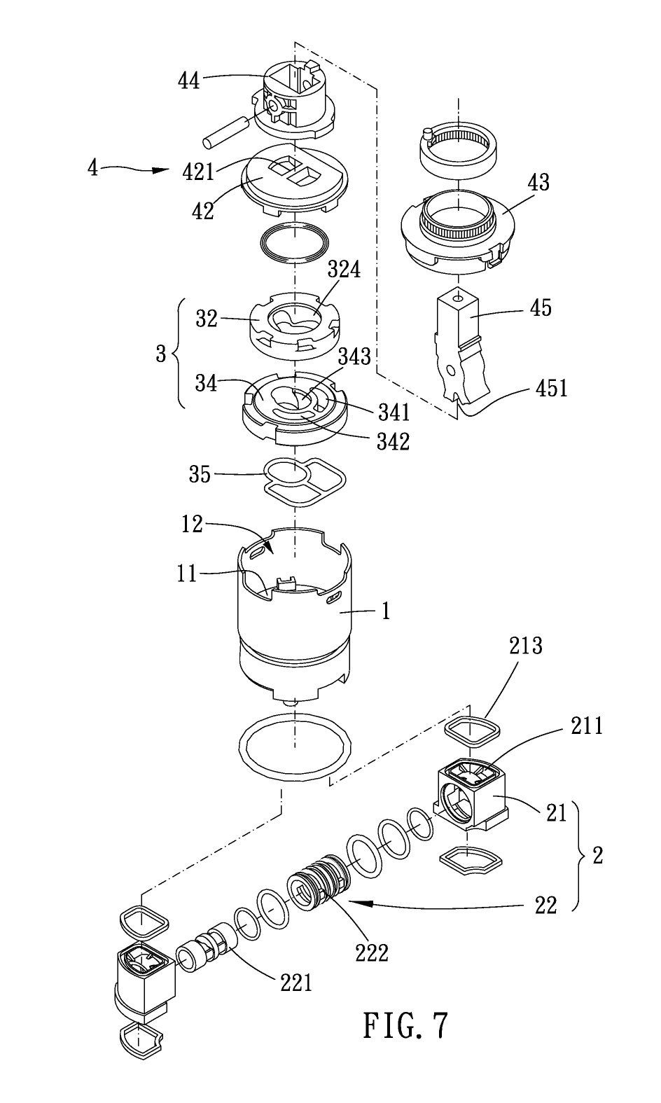

Please refer to FIG. 7 for another embodiment of the present invention. The mixing element 3 may includes a communicating disc 34 and a throttle disc 32. The communicating disc 34 is disposed in the first chamber 12 and abuts against the transversal plate 11, and the communicating disc 34 is formed with a first through bore 341, a second through bore 342 and a third through bore 343. A gasket 35 may be further provided between the communicating disc 34 and the transversal plate 11. The first through bore 341 is communicated with the first passage 111, the second through bore 342 is communicated with the second passage 112, and the third through bore 343 is communicated with the third chamber 14. The throttle disc 32 rotatably abuts against the communicating disc 34, and both discs 32 and 34 can be made of ceramics. The throttle disc 32 is formed with a mixing bore 324 which is communicated with the third through bore 343 all the time. And when the throttle disc 32 is rotated with respect to the communicating disc 34, the mixing bore 324 is selectively communicated with the first and second through bores 341 and 342.

The adjusting element 4 may include an engaging disc 42, a positioning ring 43, a rotational body 44 and a swayable rod 45. The engaging disc 42 engages with the throttle disc 32 in an operative relationship, and the engaging disc 42 is further formed with a socket 421. The positioning ring 43 is fixedly installed on the shell 1. The rotational body 44 is rotatably disposed in the positioning ring 43. The swayable rod 45 is pivoted to the rotational body 44. A lower end of the swayable rod 45 is formed with a plug 451 to plug in the sockets 421. As such, the swayable rod 45 can be swayed, and the engaging disc 42 and the throttle disc 32 are both driven to move linearly with respect to the communicating disc 34 so that a cross-section of the mixing bore 324 communicating with the third through bore 343 may be reduced or enlarged for water outlet adjustment. Or, the swayable 45 can also be rotated. Thus the rotational body 44, the engaging disc 42 and the throttle disc 32 can all be driven to rotate with respect to the communicating disc 34 for adjusting ratio of cold and hot water inlet flow.

In conclusion, all components of the water mixer of the present invention is packed in the shell to make the water mixer become an independent single piece. Thus, the water mixer is able to be installed into the faucet as a single piece quickly, and the user does not have to know how the water mixer is packed together and what components the water mixer has. On the other hand, all components of the water mixer are received in the shell, so water leaking is prevented.

What is claimed is:

1. A faucet, comprising:
a multiway tube, having a receiving portion, a cold water inlet, a hot water inlet, and an outlet, the cold water inlet, the hot water inlet, and the outlet communicating with a bottom of the receiving portion;
a water mixer, including a shell, a balance element, a mixing element, and an adjusting element, the shell having a transversal plate, the transversal plate having a first surface and a second surface, a first chamber being defined between the first surface and the shell, a second chamber and a third chamber being defined between the second surface and the shell, the transversal plate being formed with a first passage and a second passage, both of which communicate the first chamber with the second chamber, the third chamber being isolated from the second chamber, the third chamber being located below the first chamber and being communicated with the first chamber, the second chamber being below the first chamber and communicating with the cold water inlet and the hot water inlet of the multiway tube, the third chamber communicating with the outlet of the multiway tube, the balance element comprising a first tube unit, a second tube unit and a pressure balancer, the tube units being disposed in the second chamber, the first tube unit having a through hole communicated with the first passage, the second tube unit having a through hole communicated with the second passage, each tube unit having a lateral bore communicated with its through hole, the lateral bores of the tube units facing each other, a receiving space being defined between the lateral bores, the pressure balancer being movably disposed in the receiving space, the pressure balancer including a sleeve and a movable rod, the sleeve being disposed in the receiving space and having a first hole and a second hole, the first hole communicating with the cold water inlet of the multiway tube, the second hole communicating with the hot water inlet of the multiway tube, the movable rod being slidably disposed in the sleeve and having a blocked center part to partition an exterior of the movable rod into a cold water cavity and a hot water cavity, the cold water cavity and the hot water cavity communicating with the two through holes respectively, the movable rod being formed a first inlet and a second inlet on a bottom thereof, the first inlet communicating with the cold water cavity and the first hole, the second inlet communicating with the hot water cavity and the second hole, when variation between cold water and hot water changes, the movable rod being pushed by water to change overlapping area between the first hole and the first inlet and the overlapping area between the second hole and the second inlet so as to change ratio of cold water amount and hot water amount; the mixing element being disposed in the first chamber, the mixing element being adapted to regulate water to enter the first chamber via the first and second passages and to regulate the water in the first chamber to flow to the third chamber, the adjusting element connecting to the mixing element, the adjusting element being adapted to control a movement of the mixing element so as to further adjust a mixing ratio of a flow rate in the first passage to a flow rate in the second passage.

2. The faucet of claim 1, wherein the mixing element comprises two sealing gaskets and a throttle disc, the sealing gaskets abut against the transversal plate respectively, each sealing gasket defines a through bore communicated with one of the first and second passages, the throttle disc abuts against the sealing gaskets, the throttle disc is formed with a first slot and a second slot, the adjusting element and the throttle disc are in a rotational operative relationship, so that the first and second slots on the throttle disc are controlled to selectively communicate the through bores with the first chamber respectively.

3. The faucet of claim 2, wherein two annular rims are axially extended from the first surface of the transversal plate, the annular rims surround one of the first passage and the second passage respectively, the sealing gaskets are tightly surrounded by the annular rims respectively.

4. The faucet of claim 1, wherein the mixing element comprises a communicating disc and a throttle disc, the communicating disc is disposed in the first chamber, the communicating disc is formed with a first through bore, a second through bore and a third through bore, the first through bore is communicated with the first passage, the second through bore is communicated with the second passage, the third through bore is communicated with the third chamber, the throttle disc rotatably abuts against the communicating disc, the throttle disc is formed with a mixing bore, the mixing bore is selectively communicated with the first through bore and the second through bore, the mixing bore is communicated with the third through bore, the adjusting element and the throttle disc is in a rotational operative relationship, so that the throttle disc is controlled to selectively rotate with respect to the communicating disc.

5. The faucet of claim 1, wherein two blocking plates are disposed in each of the through holes of the tube units, the tube units has several intensifying plates, each intensifying plate connects one of the blocking plates with its corresponding tube unit.

6. The faucet of claim 5, wherein each intensifying plate has a surface, the surface of each intensifying plate has a normal direction, an orientation of the through hole is perpendicular to the normal direction.
